(19) United States
(12) Patent Application Publication
(10) Pub. No.: US 2026/0291021 A1
(43) Pub. Date: Sep. 24, 2026

(54) WIRING MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yuhei YAMADA, Osaka (JP); Hideo TAKAHASHI, Osaka (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 19/489,309

(22) PCT Filed: Jun. 11, 2024
(86) PCT No.: PCT/JP2024/021178

§ 371 Date: Dec. 2, 2025

(30) Foreign Application Priority Data
Jun. 14, 2023 (JP) 2023-097456

(51) Int. Cl. H01M 50/526; H01M 50/503; H01M 50/522

(52) U.S. Cl. CPC H01M 50/526; H01M 50/503; H01M 50/522

(57) ABSTRACT

A wiring module is a wiring module configured to be attached to a plurality of power storage elements having electrode terminals. The wiring module includes: a busbar; and a wiring material, wherein the busbar includes: electrode connection portions configured to be connected to the electrode terminals; and a laminated portion that is formed by laminating a plurality of plate-shaped base materials and connects the two electrode connection portions to each other, the two electrode connection portions being adjacent to the laminated portion, and the laminated portion has a wiring material connection portion that is electrically connected to the wiring material.

### TECHNICAL FIELD

The present disclosure relates to a wiring module.

### BACKGROUND ART

Conventionally, the busbar disclosed in JP 2023-47446A (Patent Document 1 below) is known. The busbar of Patent Document 1 includes two connection portions and an intermediate portion that connects the two connection portions to each other. The connection portions are portions that are connected to electrode terminals of power storage elements. The intermediate portion has a mountain shape protruding upward from the connection portions. This intermediate portion can absorb misalignment between the two connection portions. The busbar is formed by laminating a plurality of plate-shaped base materials in the up-down direction. This allows the formation of a more flexible intermediate portion, compared to a case where the busbar is formed of a single metal plate material.

Also, JP 2019-207825 (Patent Document 2 below) describes a wiring module that includes a connection busbar connected to electrode terminals and a voltage detection wire. This connection busbar has a bent portion that protrudes in a direction (upward) away from the electrode terminals. The voltage detection wire is connected, via a voltage detection terminal, to a portion (different from the bent portion) of the connection busbar that is connected to the electrode terminal.

### CITATION LIST

### Patent Documents

Patent Document 1: JP 2023-47446A

Patent Document 2: JP 2019-207825A

### SUMMARY OF INVENTION

### Technical Problem

When a wiring material such as a voltage detection wire is connected to the busbar of Patent Document 1 to form a wiring module, if the configuration described in Patent Document 2 is applied, the wiring material will be connected to the connection portions of the busbar. However, for example, when the busbar is miniaturized, it may be difficult to achieve both the connection between the connection portions and the wiring material, and the connection between the connection portions and the electrode terminals.

Also, although it is preferable for the connection portions to have a predetermined strength for the process of connecting to the electrode terminals, the busbar of Patent Document 1 is formed by laminating a plurality of base materials, and thus the strength of the connection portions may be reduced.

### Solution to Problem

A wiring module according to the present disclosure is a wiring module configured to be attached to a plurality of power storage elements having electrode terminals, the wiring module including: a busbar; and a wiring material, wherein the busbar includes electrode connection portions configured to be connected to the electrode terminals, and a laminated portion that is formed by laminating a plurality of plate-shaped base materials and connects the two electrode connection portions to each other, the two electrode connection portions being adjacent to the laminated portion, and the laminated portion has a wiring material connection portion that is electrically connected to the wiring material.

### Advantageous Effects of Invention

According to the present disclosure, it is possible to provide a wiring module that has excellent connection reliability between a busbar and electrode terminals, as well as between the busbar and a wiring material.

### BRIEF DESCRIPTION OF DRAWINGS

FIG. 1 is a plan view of a power storage module according to Embodiment 1.

FIG. 2 is an enlarged perspective view of a wiring module according to Embodiment 1.

FIG. 3 is an enlarged bottom view of the wiring module according to Embodiment 1.

FIG. 4 is a plan view of a busbar according to Embodiment 1.

FIG. 5 is a side view of the busbar according to Embodiment 1.

FIG. 6 is an enlarged side view of a laminated portion of the busbar shown in FIG. 5.

FIG. 7 is an enlarged perspective view of a wiring module according to Embodiment 2.

FIG. 8 is an enlarged bottom view of the wiring module according to Embodiment 2.

FIG. 9 is an enlarged perspective view of a wiring module according to another embodiment.

### DESCRIPTION OF EMBODIMENTS

### Description of Embodiments of Present Disclosure

First, embodiments of the present disclosure will be listed and described.

[1] A wiring module according to the present disclosure is a wiring module configured to be attached to a plurality of power storage elements having electrode terminals, the wiring module including: a busbar; and a wiring material, wherein the busbar includes electrode connection portions configured to be connected to the electrode terminals, and a laminated portion that is formed by laminating a plurality of plate-shaped base materials and connects the two electrode connection portions to each other, the two electrode connection portions being adjacent to the laminated portion, and the laminated portion has a wiring material connection portion that is electrically connected to the wiring material.

According to this configuration, the electrode connection portions can be formed separately from the laminated portion in which the plurality of base materials are laminated together, and thus it is possible to improve the strength of the electrode connection portions. This makes it easier to realize electrical connection between the electrode connection portions and the electrode terminals.

Also, according to the above-described configuration, the busbar and the wiring material can be electrically connected to each other using the wiring material connection portion included in the laminated portion. Also, since the wiring material connection portion does not need to be provided in any of the electrode connection portions, it is easier to ensure the electrical connection between the electrode connection portions and the electrode terminals, even when the busbar is miniaturized, for example.

[2] In the above-described configuration [1], preferably, the laminated portion includes overlap portions that respectively overlap the electrode connection portions and are connected to the electrode connection portions, and one of the overlap portions has the wiring material connection portion.

According to this configuration, the wiring material connection portion is formed in the overlap portion of the laminated portion that is connected to the electrode connection portion. The overlap portion is a portion of the laminated portion that is less flexible, due to its configuration in which the overlap portion overlaps the electrode connection portion and is connected to the electrode connection portion. Therefore, by providing the wiring material connection portion on the overlap portion, it is possible to suppress the loss of flexibility in the portion of the laminated portion that does not overlap the electrode connection portion, as well as the application of stress to the connection part between the wiring material connection portion and the wiring material.

[3] In the above-described configuration [1] or [2], preferably, the electrode connection portions are made of a first metal, the plurality of base materials include at least one first base material made of the first metal, and at least one second base material made of a second metal that is different from the first metal, the wiring material includes a conductor portion made of the second metal, the electrode connection portions are connected to the first base material, and the wiring material connection portion is formed of the second base material and is connected to the conductor portion.

According to this configuration, the connection between the electrode connection portion and the laminated portion, as well as the connection between the wiring material connection portion and the wiring material, are connections between metals of the same type. Therefore, these connections are facilitated.

[4] In any one of the above-described configurations [1] to [3], preferably, the laminated portion includes a protrusion that protrudes outward relative to the electrode connection portions in a third direction that is orthogonal to both a first direction in which the electrode connection portions are lined up and a second direction in which the electrode connection portions face the electrode terminals, and the protrusion includes the wiring material connection portion.

According to this configuration, it is possible to connect the wiring material and the wiring material connection portion, even with the wiring material extending in the first direction.

### Detail of Embodiments of Present Disclosure

The following will describe embodiments of the present disclosure. The present disclosure is not limited to these examples, but is intended to include all changes within the meaning and scope equivalent to the claims. For convenience of description, some features may be exaggerated or simplified in the drawings. In addition, the dimensional ratios of each part may differ among the drawing. In the context of the present specification, the term “orthogonal” includes not only exactly orthogonal, but also substantially orthogonal to the extent that the functions and effects of the embodiments are achieved.

Also, the term “facing” in this specification means that surfaces or members are at positions in front of each other, and includes not only the case where they completely face each other, but also the case where they partially face each other. Also, the term “facing” in this specification includes both the case where a different member is interposed between two facing members and the case where nothing is interposed between two facing members.

### Embodiment 1

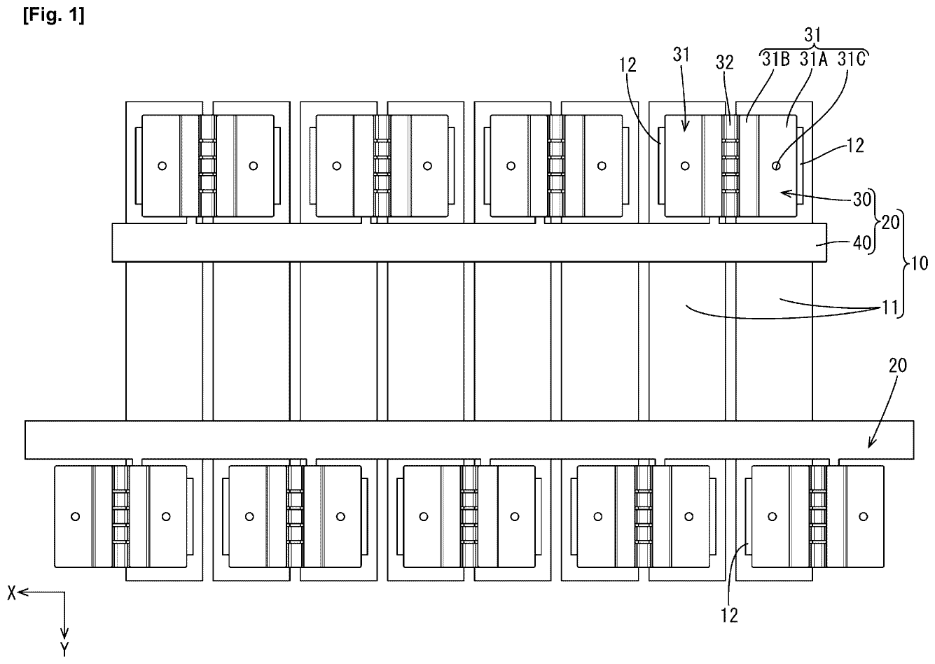

The following will describe Embodiment 1 of the present disclosure with reference to FIGS. 1 to 6. The power storage module 10 including a wiring module 20 of the present embodiment is mounted in a vehicle, such as an electric automobile or a hybrid automobile, to serve as a power supply for driving the vehicle. In the following description, the direction indicated by an arrow Z refers to upward, the direction indicated by an arrow X refers to forward, and the direction indicated by an arrow Y refers to leftward. Note that, for multiple identical components, a reference numeral may be added to only some of the components, and may be omitted for the other components.

As shown in FIG. 1, the power storage module 10 includes a plurality of power storage elements 11 lined up in a row and wiring modules 20 mounted on the upper surfaces of the plurality of power storage elements 11. The wiring modules 20 are respectively attached to both end portions of the plurality of power storage elements 11 in a left right direction. Each of power storage elements 11 has the shape of a flat cuboid in which a power storage element is housed. Each of the power storage elements 11 includes two electrode terminals 12 at both end portions of its upper surface in a left right direction. One of the two electrode terminals 12 is a positive electrode and the other is a negative electrode. The electrode terminals 12 are electrically connected to busbars 30.

### Wiring Module 20

As shown in FIGS. 1 to 3, each wiring module 20 includes busbars 30 and a wiring material 40 connected to the busbars 30.

### Busbar 30, Electrode Connection Portion 31, and First Metal M1

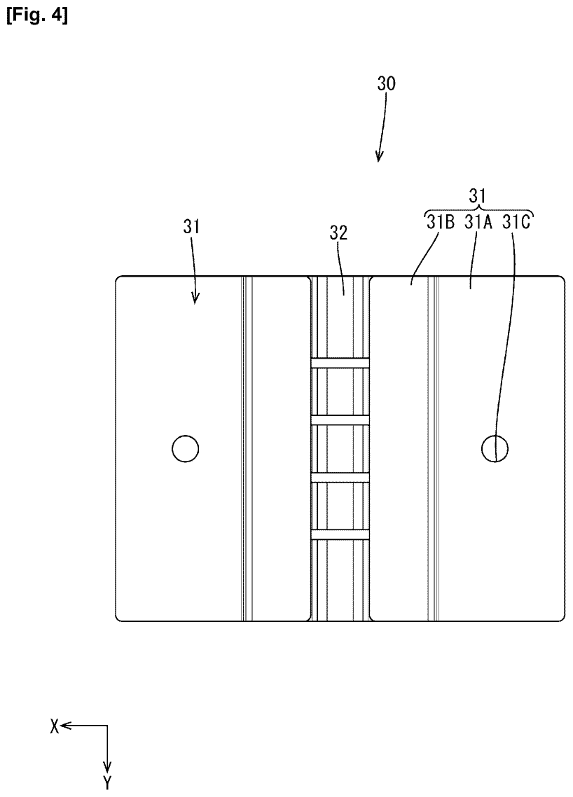

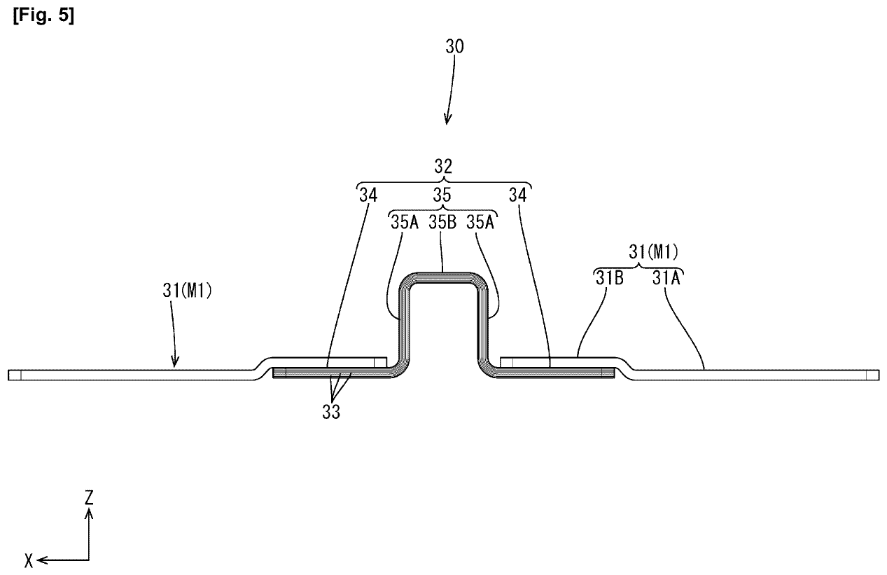

As shown in FIG. 4, the busbar 30 has a square shape when viewed in a plan view. The busbar 30 includes two electrode connection portions 31 and a laminated portion 32 that connects the two electrode connection portions 31 to each other, the two electrode connection portions 31 being adjacent to the laminated portion. The two electrode connection portions 31 are lined up in a front-rear direction. As shown in FIG. 5, the electrode connection portions 31 are each formed by bending and processing a single metal plate material. In the present embodiment, the electrode connection portions 31 are made of a first metal M1. The first metal M1 is, for example, aluminum or an aluminum alloy. The electrode connection portions 31 each include a main body portion 31A and an extension portion 31B extending from the main body portion 31A. As shown in FIG. 4, the electrode connection portions 31 each have a through hole 31C that passes through the main body portion 31A in an up-down direction.

As shown in FIG. 1, the main body portion 31A is arranged to face the electrode terminal 12 in the up-down direction, and is connected to the electrode terminal 12, for example, by welding. In the present embodiment, the electrode terminal 12 is made of the first metal M1. Since the electrode terminal 12 and the main body portion 31A are made of the same type of metal, electrical connection between the electrode terminal 12 and the main body portion 31A is facilitated. Also, electrolytic corrosion in the connection part between the electrode terminal 12 and the main body portion 31A is prevented. The through hole 31C engages with a protruding portion (not shown) that protrudes from the electrode terminal 12. With this, the positioning of the busbar 30 relative to the electrode terminal 12 is realized.

### Laminated Portion 32, Base Material 33, First Base Material 33A, Second Base Material 33B, and Second Metal M2

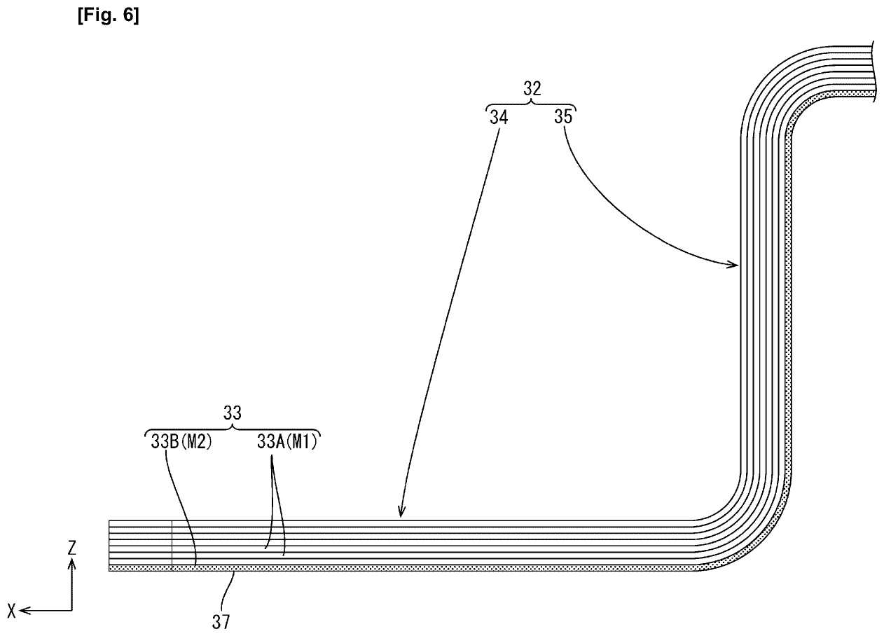

As shown in FIGS. 5 and 6, the laminated portion 32 is formed by laminating a plurality of plate-shaped base materials 33. The base materials 33 are, for example, thin metal materials or metal foils. The plurality of base materials 33 are connected to each other by, for example, welding, brazing, or the like. As shown in FIG. 6, in the present embodiment, the plurality of base materials 33 include a plurality of (specifically seven) first base materials 33A and one second base material 33B. The first base materials 33A are made of the first metal M1. The second base material 33B is made of a second metal M2, which is different from the first metal M1. The second metal M2 is, for example, copper or a copper alloy.

### Overlap Portion 34

As shown in FIG. 5, the laminated portion 32 includes two overlap portions 34 that overlap the extension portion 31B, and a main body portion 35 located between the two overlap portions 34. In the present embodiment, the overlap portion 34 is placed beneath the extension portion 31B. The upper surface of the overlap portion 34 is connected to the extension portion 31B, for example, by welding. As shown in FIG. 6, in the overlap portion 34, the first base materials 33A and the second base material 33B are laminated in the up-down direction, with the second base material 33B positioned at the lowest level among the plurality of base materials 33. The plurality of first base materials 33A are arranged on top of the single second base material 33B. That is, the upper surface of the overlap portion 34 is formed of the first base material 33A and is made of the first metal M1. Since the extension portion 31B is also made of the first metal M1, electrical connection between the upper surface of the overlap portion 34 and the extension portion 31B is facilitated. Furthermore, electrolytic corrosion in the connection part between the overlap portion 34 and the extension portion 31B is prevented.

As shown in FIG. 5, in the present embodiment, the main body portion 35 has a mountain shape protruding upward from the overlap portions 34. The main body portion 35 includes two side portions 35A rising from the overlap portions 34 and a ceiling portion 35B that connects the upper ends of the two side portions 35A. By forming the main body portion 35 in a mountain shape, the main body portion 35 is elastically deformable, allowing a certain degree of displacement resulting from a shift between the two electrode connection portions 31 relative to each other in the front-rear direction and the up-down direction. Accordingly, it is possible to absorb an assembly tolerance and the like between the electrode connection portions 31 and the electrode terminals 12. It is also possible to allow expansion and contraction of the power storage elements 11 due to temperature changes.

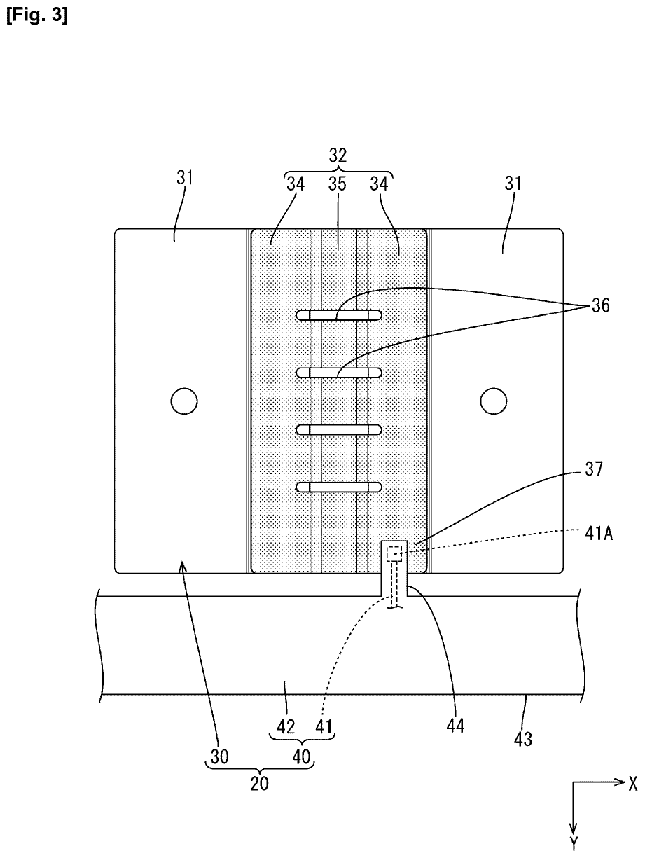

As shown in FIG. 3, the laminated portion 32 has a plurality of slits 36 that pass through the main body portion 35 and the sections of the overlap portions 34 that are close to the main body portion 35. Each slit 36 extends in the front-rear direction. By providing the slits 36 in the main body portion 35, a certain degree of displacement resulting from a shift between the two electrode connection portions 31 relative to each other in the left right direction is allowed. Therefore, it is possible to allow expansion and contraction of the power storage elements 11 due to temperature changes.

### Wiring Material Connection Portion 37

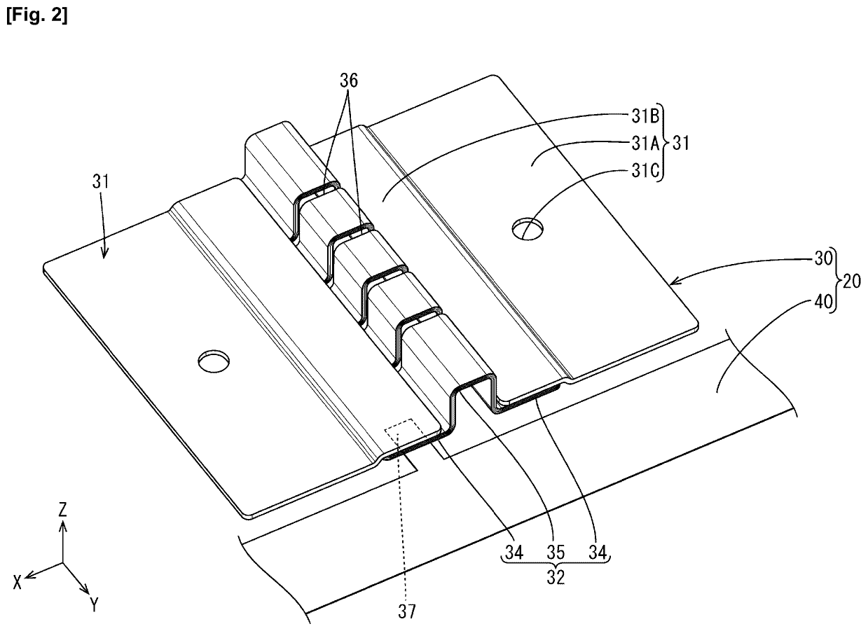

As shown in FIGS. 2 and 3, one of the two overlap portions 34 of the laminated portion 32 includes a wiring material connection portion 37. The wiring material connection portion 37 is a portion of the busbar 30 that is electrically connected to the later-described wiring material 40. In FIGS. 2 and 3, the wiring material connection portion 37 is disposed on the overlap portion 34 provided on the front side. The wiring material connection portion 37 is located on the lower surface of the overlap portion 34. In the overlap portion 34, the base material 33 positioned at the lowest level is the second base material 33B (see FIG. 6). Therefore, the wiring material connection portion 37 is part of the second base material 33B and is made of the second metal M2.

### Wiring Material 40

As shown in FIG. 3, the wiring material 40 includes a conductor portion 41 and a support member 42 that supports the conductor portion 41. In the present embodiment, the wiring material 40 is a flexible printed circuit board. The support member 42 is made of an insulating synthetic resin and includes a base film and a coverlay film. In the present embodiment, the conductor portion 41 is made of the second metal M2. The conductor portion 41 has the shape of a fine wire. A land portion 41A is formed at the end of the conductor portion 41. The land portion 41A is wider than the other portions of the conductor portion 41. The conductor portion 41 is formed on the base film and covered by the coverlay film from above. An opening is formed in the coverlay film to expose the land portion 41A upward.

The wiring material 40 includes a main body portion 43 extending in the front-rear direction and a connection piece 44 extending from the main body portion 43 in the left right direction. The land portion 41A is provided on the connection piece 44. The connection piece 44 is placed beneath the wiring material connection portion 37 of the overlap portion 34. The land portion 41A and the wiring material connection portion 37 are connected to each other, for example, by soldering or the like. Since the land portion 41A and the wiring material connection portion 37 are made of the second metal M2, the electrical connection between the land portion 41A and the wiring material connection portion 37 is facilitated.

The end of the conductor portion 41 that is opposite to the land portion 41A is connected to a not shown connector. This connector is designed to be connected to an external ECU (Electronic Control Unit) or the like. The ECU is a unit on which a microcomputer, elements, and the like are mounted, and has a well-known configuration having functions of, for example, sensing a voltage, a current, a temperature and the like of the power storage elements 11, and controlling charging/discharging of the power storage elements 11. The conductor portion 41 functions as a voltage detection wire.

The overlap portions 34 of the laminated portion 32 are connected to the electrode connection portions 31 and are unlikely to deform. On the other hand, the main body portion 35 of the laminated portion 32 is elastically deformable and is flexible. In contrast to the present embodiment, if the wiring material connection portion is provided on the main body portion, the flexibility of the main body portion may deteriorate due to being connected to the wiring material. Furthermore, stress may be applied to the connection part between the wiring material connection portion and the wiring material when the main body portion deforms. However, in the present embodiment, the wiring material connection portion 37 is provided on the overlap portion 34 rather than on the main body portion 35. This makes it possible to maintain the connection reliability between the busbar 30 and the wiring material 40, without deteriorating the flexibility of the main body portion 35.

### Operations and Effects of Embodiment 1

(1-1) The wiring module 20 according to Embodiment 1 is a wiring module 20 configured to be attached to a plurality of power storage elements 11 having electrode terminals 12, the wiring module 20 including: a busbar 30; and a wiring material 40, wherein the busbar 30 includes: electrode connection portions 31 configured to be connected to the electrode terminals 12; and a laminated portion 32 that is formed by laminating a plurality of plate-shaped base materials 33 and connects the two electrode connection portions 31 to each other, the two electrode connection portions 31 being adjacent to the laminated portion 32, and the laminated portion 32 has a wiring material connection portion 37 that is electrically connected to the wiring material 40.

According to this configuration, the electrode connection portions 31 can be formed separately from the laminated portion 32 in which the plurality of base materials 33 are laminated, and thus it is possible to improve the strength of the electrode connection portions 31. This makes it easier to realize electrical connection between the electrode connection portions 31 and the electrode terminals 12.

Also, according to the above-described configuration, the busbar 30 and the wiring material 40 can be electrically connected to each other using the wiring material connection portion 37 included in the laminated portion 32. Also, since the wiring material connection portion 37 does not need to be provided in any of the electrode connection portions 31, it is easier to ensure the electrical connection between the electrode connection portions 31 and the electrode terminals 12, even when the busbar 30 is miniaturized, for example.

(1-2) In Embodiment 1, the laminated portion 32 includes overlap portions 34 that respectively overlap the electrode connection portions 31 and are connected to the electrode connection portions 31, and one of the overlap portions 34 has the wiring material connection portion 37.

According to this configuration, the wiring material connection portion 37 is formed on the overlap portion 34 of the laminated portion 32 that is connected to the electrode connection portion 31. The overlap portion 34 is a portion of the laminated portion 32 that is less flexible, due to its configuration in which the overlap portion 34 overlaps the electrode connection portion 31 and is connected to the electrode connection portion 31. Therefore, by providing the wiring material connection portion 37 on the overlap portion 34, it is possible to suppress the loss of flexibility in the portion of the laminated portion 32 that does not overlap the electrode connection portion 31, as well as the application of stress to the connection part between the wiring material connection portion 37 and the wiring material 40.

(1-3) In Embodiment 1, the electrode connection portions 31 are made of a first metal M1, the plurality of base materials 33 include at least one first base material 33A made of the first metal M1, and at least one second base material 33B made of a second metal M2, which is different from the first metal M1, the wiring material 40 includes a conductor portion 41 made of the second metal M2, the electrode connection portions 31 are connected to the first base material 33A, and the wiring material connection portion 37 is formed of the second base material 33B and is connected to the conductor portion 41.

According to this configuration, for example, when the electrode terminals 12 are made of the first metal M1 and the conductor portion 41 is made of the second metal M2, the connection between the electrode terminals 12 and the electrode connection portions 31, the connection between the electrode connection portions 31 and the laminated portion 32, and the connection between the wiring material connection portion 37 and the wiring material 40 are connections between metals of the same type. Therefore, these connections are facilitated.

### Embodiment 2

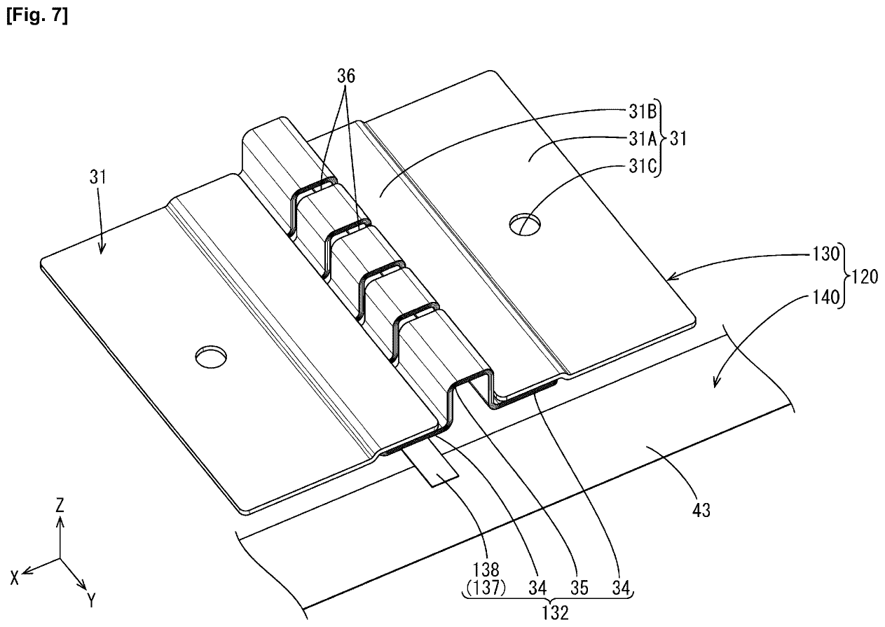

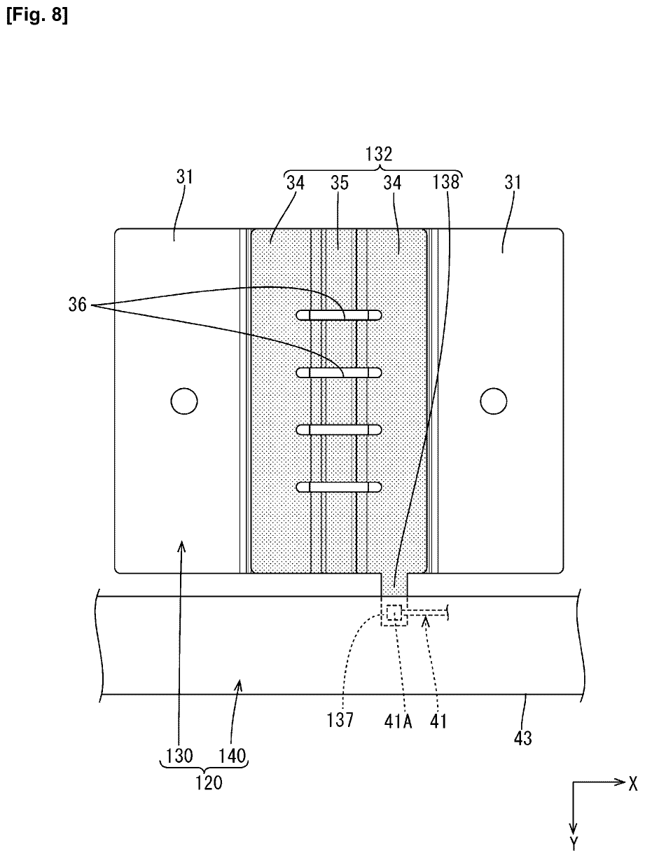

The following will describe Embodiment 2 of the present disclosure with reference to FIGS. 7 and 8. A wiring module 120 according to Embodiment 2 includes a busbar 130 and a wiring material 140. In the present embodiment, the front-rear direction is an example of a first direction. The up-down direction is an example of a second direction. The left right direction is an example of a third direction. Hereinafter, the same reference numerals as in Embodiment 1 may be given to the components that are the same as those of Embodiment 1, and descriptions thereof may be omitted. Also, redundant descriptions regarding the operations and effects overlapping those in Embodiment 1 are omitted.

The busbar 130 includes two electrode connection portions 31 and a laminated portion 132. Similar to Embodiment 1, the laminated portion 132 includes a plurality of first base materials 33A, and one second base material 33B placed beneath the plurality of first base materials 33A (see FIG. 6). The laminated portion 132 has a protrusion 138 protruding leftward from the electrode connection portions 31 in the width direction (left-right direction) of the busbar 30. The protrusion 138 is formed only of the second base material 33B. The protrusion 138 includes, on its lower surface, a wiring material connection portion 137.

The wiring material 140 does not include the connection piece 44 of Embodiment 1, but only includes the main body portion 43 extending in the front-rear direction. That is, the wiring material 140 is arranged in the wiring module 120 while extending in the front-rear direction. As shown in FIG. 8, a land portion 41A is formed on the main body portion 43. The protrusion 138 is arranged on the land portion 41A, and the land portion 41A and the wiring material connection portion 137 are connected to each other by soldering or the like.

In the present embodiment, the connection part between the busbar 130 and the wiring material 140 is formed by the protrusion 138, instead of the connecting piece 44 of Embodiment 1. With this, it is possible to realize the connection between the wiring material 140 and the wiring material connection portion 137, with the wiring material 140 extending in the front-rear direction. That is, since the wiring material 140 can be formed in a simple strip shape, it is easy to form the wiring material 140. Also, the protrusion 138 is formed of the base material 33, and is likely to have enhanced strength compared to the connection piece 44. Therefore, it is possible to improve the connection reliability between the busbar 130 and the wiring material 140.

### Operations and Effects of Embodiment 2

(2-1) In the wiring module 120 according to Embodiment 2, the laminated portion 132 includes a protrusion 138 that protrudes outward relative to the electrode connection portions 31 in a third direction (left-right direction) that is orthogonal to both a first direction (front-rear direction) in which the electrode connection portions 31 are lined up and a second direction (up-down direction) in which the electrode connection portions 31 face the electrode terminals 12, and the protrusion 138 includes the wiring material connection portion 137.

According to this configuration, it is possible to connect the wiring material 140 and the wiring material connection portion 137, even with the wiring material 140 extending in the first direction.

### Other Embodiments

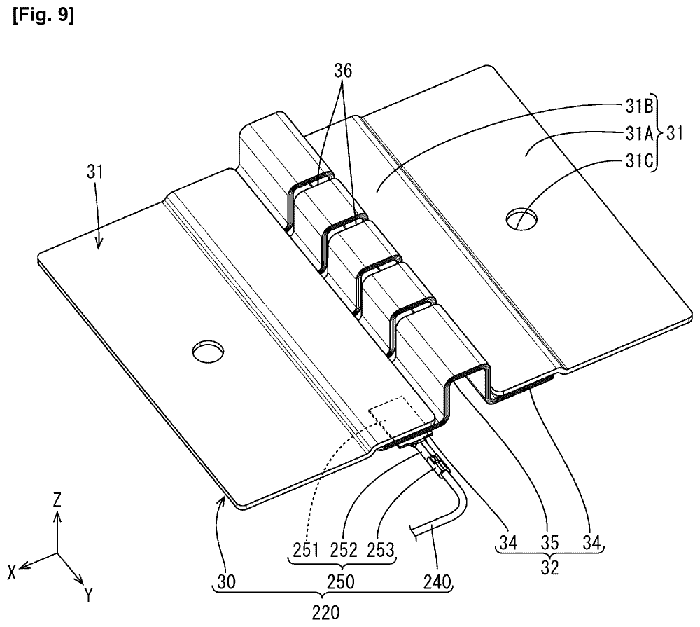

Embodiments 1 and 2 above can be implemented in the following modifications. Embodiments 1 and 2 above and the following modifications can be combined with each other and implemented as long as no technical contradiction arises.
In Embodiments 1 and 2 above, the busbars 30 and 130 are made of the first metal M1 and the second metal M2, but the busbars may be made of a single type of metal.
In Embodiments 1 and 2 above, the plurality of base materials 33 include the plurality of first base materials 33A and the single second base material 33B, but the numbers of first base materials and second base materials included in the plurality of base materials may be changed as appropriate. Furthermore, all of the plurality of base materials may be made of a single type of metal.
In Embodiments 1 and 2 above, the laminated portion 32, 132 and the electrode connection portion 31 are connected to each other by welding, but the laminated portion and the electrode connection portion may also be electrically connected to each other by being mechanically compressed and fixed.
In Embodiments 1 and 2 above, the laminated portion 32, 132 has the main body portion 35 protruding from the overlap portions 34, but the main body portion 35 may also be flat plate-shaped in a manner such that it is substantially flush with the overlap portion 34.
In Embodiments 1 and 2 above, the slits 36 are formed in the laminated portion 32, 132, but there may be no slit.
In Embodiment 1 above, the wiring material connection portion 37 is provided on the overlap portion 34, but the wiring material connection portion may also be provided on the main body portion.
In Embodiment 2 above, the protrusion 138 may protrude not only from the overlap portion 34 but also from the main body portion 35, as long as it protrudes outward relative to the electrode connection portion 31 in the third direction. Also, the protrusion 138 may be formed of any of the base materials 33 constituting the laminated portion 33.
In Embodiments 1 and 2 above, the wiring materials 40 and 140 are flexible printed circuit boards, but the wiring materials may also be, for example, wires or FFCs (Flexible Flat Cables). Furthermore, the wiring materials may be electrically connected to the busbars via terminals, metal pieces, or the like. For example, the wiring modules of the present disclosure include a wiring module 220 shown in FIG. 9. The wiring module 220 includes a busbar 30, a wiring material 240, and a terminal 250. The wiring material 240 is an electric wire. The terminal 250 includes a terminal body 251 welded to the busbar 30, a core wire crimped portion 252 crimped to the core wire of the electric wire, and an insulation coating crimped portion 253 crimped to the insulation coating of the electric wire.

### LIST OF REFERENCE NUMERALS

10: Power storage module
11: Power storage element
12: Electrode terminal
20: Wiring module
30: Busbar
31: Electrode connection portion
31A: Main body portion
31B: Extension portion
31C: Through hole
32: Laminated portion
33: Base material
33A: First base material
33B: Second base material
34: Overlap portion
35: Main body portion
35A: Side portion
35B: Ceiling portion
36: Slit
37: Wiring material connection portion
40: Wiring material
41: Conductor portion
41A: Land portion
42: Support member
43: Main body portion
44: Connection piece
120: Wiring module
130: Busbar
132: Laminated portion
137: Wiring material connection portion
138: Protrusion
140: Wiring material
220: Wiring module
240: Wiring material
250: Terminal
251: Terminal body
252: Core wire crimped portion
253: Insulation coating crimped portion
M1: First metal
M2: Second metal

1. A wiring module configured to be attached to a plurality of power storage elements having electrode terminals, the wiring module comprising:
a busbar; and
a wiring material,
wherein the busbar includes two electrode connection portions configured to be connected to the electrode terminals, and a laminated portion that is formed by laminating a plurality of plate-shaped base materials and connects the two electrode connection portions to each other, the two electrode connection portions being adjacent to the laminated portion, and
the laminated portion has a wiring material connection portion that is electrically connected to the wiring material.

2. The wiring module according to claim 1,
wherein the laminated portion includes overlap portions that respectively overlap the electrode connection portions and are connected to the electrode connection portions, and
one of the overlap portions has the wiring material connection portion.

3. The wiring module according to claim 1,
wherein the electrode connection portions are made of a first metal,
the plurality of base materials include at least one first base material made of the first metal, and at least one second base material made of a second metal that is different from the first metal,
the wiring material includes a conductor portion made of the second metal,
the electrode connection portions are connected to the first base material, and
the wiring material connection portion is formed of the second base material and is connected to the conductor portion.

4. The wiring module according to claim 1,
wherein the laminated portion includes a protrusion that protrudes outward relative to the electrode connection portions in a third direction that is orthogonal to both a first direction in which the electrode connection portions are lined up and a second direction in which the electrode connection portions face the electrode terminals, and
the protrusion includes the wiring material connection portion.

5. The wiring module according to claim 2,
wherein the electrode connection portions are made of a first metal,
the plurality of base materials include at least one first base material made of the first metal, and at least one second base material made of a second metal that is different from the first metal,
the wiring material includes a conductor portion made of the second metal,
the electrode connection portions are connected to the first base material, and
the wiring material connection portion is formed of the second base material and is connected to the conductor portion.

6. The wiring module according to claim 2,
wherein the laminated portion includes a protrusion that protrudes outward relative to the electrode connection portions in a third direction that is orthogonal to both a first direction in which the electrode connection portions are lined up and a second direction in which the electrode connection portions face the electrode terminals, and
the protrusion includes the wiring material connection portion.
